(19) United States
(12) Patent Application Publication
(10) Pub. No.: US 2012/0153726 A1
(43) Pub. Date: Jun. 21, 2012

(54) Energy storage system and method of controlling the same

(76) Inventor: Chong-Sop Moon, Yongin-si (KR)

(21) Appl. No.: 13/067,443

(22) Filed: Jun. 1, 2011

(30) Foreign Application Priority Data
Dec. 16, 2010 (KR) 10-2010-0129287

(51) Int. Cl. H02J 3/32

(52) U.S. Cl. 307/46

(57) ABSTRACT

An energy storage system includes a storage device for storing energy generated by an energy generation system and for supplying the energy to an electric power system, and a controller for monitoring an output of the storage device and, when the output is within an abnormal output range, for controlling the output to be in a normal output range.

### BACKGROUND

1. Field

One or more embodiments relate to an energy storage system and a method of controlling the same.

2. Description of the Related Art

Recently, energy industries are getting an increased attention due to energy related problems, e.g., destruction of the natural environment and energy exhaustion. Meanwhile, energy generated by power plants is mostly used during the daytime for industrial activities and household activities. However, during the nighttime, excess energy remains. To promote use of energy at night, power generation companies sell energy for much lower prices during the nighttime than during the daytime.

### SUMMARY

One or more embodiments include a storage system and a method of controlling the same, in which the energy storage system controls a storage device for storing or supplying energy in connection with an energy generation system, an electric power system, and a load when the storage device produces an abnormal output.

The energy storage system may include a storage device configured to store energy generated by an energy generation system and to supply the stored energy to an electric power system, and a controller configured to monitor an output of the storage device and, when the output is within an abnormal output range, to control the output to be in a normal output range.

The controller may compare a predetermined reference range with the output of the storage device and may determine whether the output is in the abnormal output range, and if the output is determined to be within the abnormal output range, the controller may generate a control signal for increasing or decreasing the abnormal output of the storage device to be within predetermined reference range, and the energy storage system may include an energy converter for increasing or dropping the output according to a control signal transmitted by the controller.

The energy storage system may further include a storage device management module for obtaining state information of the storage device and transmitting the state information to the controller.

The storage device may include a plurality of battery units electrically connected to each other.

The controller may obtain state information of each of the battery units, and may determine whether the output of the storage device is in the abnormal output range based on the state information.

The storage device may include a plurality of battery units, and a plurality of energy converters electrically connected to respective battery units.

The controller may compare the predetermined reference range of the battery units with output voltages of the battery units and may determine whether the output voltages are within the abnormal output range, and if the output voltages are within the abnormal output range, the controller may transmit a control signal for increasing or decreasing the output voltages to be within the predetermined reference range to energy converters that are electrically connected to the battery units.

According to one or more embodiments, an energy storage system may include a first interface connected to an energy generation system, a second interface connected to an electric power system, a third interface connected to a load, a storage device for storing at least one of energy generated by the energy generation system and energy supplied by the electric power system and supplying the stored energy to at least one of the electric power system and the load, and a controller for monitoring an output of the storage device and, when the output is determined to be within an abnormal output range, controlling the output to be a normal output range.

The controller may compare a predetermined reference range with the output of the storage device and may determine whether the output is in the abnormal output range, and if the output is determined to be within the abnormal output range, the controller may generate a control signal for increasing or decreasing the abnormal output of the storage device to be within the reference range, and the energy storage system may include an energy converter for increasing or decreasing the output according to a control signal transmitted by the controller.

The energy storage system may further include a storage device management module for obtaining state information of the storage device and transmitting the state information to the controller.

The storage device may include a plurality of battery units electrically connected to each other.

The controller may obtain state information of each of the battery units, and may determine whether the output of the storage device is in the abnormal output range based on the state information.

The storage device may include a plurality of battery units, and a plurality of energy converters electrically connected to respective battery units.

The controller may compare a predetermined reference range of the battery units with output voltages of the battery units and may determine whether the output voltages are within the abnormal output range, and if the output voltages are within the abnormal output range, the controller may transmit a control signal for increasing or decreasing the output voltages so that the output of each of the battery units is within the reference range to energy converters that are electrically connected to battery units that are determined to be in the abnormal output range.

The controller may include a first control unit for controlling supply of the energy generated by the energy generation system to at least one of the load, the storage device, and the electric power system, a second control unit for controlling supply of commercially available energy supplied by the electric power system to at least one of the load and the storage device, a third control unit for controlling supply the energy stored in the storage device to at least one selected of the load and the electric power system, and a fourth control unit for sensing whether the output of the storage device is within the abnormal output range and determining an output increase or drop ratio of the abnormal output voltage.

The energy storage system may further include a first energy conversion unit that is connected to the first interface and converts the energy generated by the energy generation system, a second energy conversion unit that is connected to the second interface and the third interface and converts energy supplied to the electric power system and the load, and a third energy conversion unit that is interposed between and connected to the storage device and a node between the first energy conversion unit and the second energy conversion unit and converts the energy stored in the storage device and outputs the energy to the node.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic block diagram of an energy storage system according to an embodiment;

FIG. 2 illustrates a detailed block diagram of the energy storage system of FIG. 1;

FIG. 3 illustrates a schematic block diagram of an energy storage system according to another embodiment;

FIG. 4 illustrates a schematic conceptual diagram of a storage device included in the energy storage system of FIG. 3;

FIG. 5 illustrates a flowchart of energy and control signals of the energy storage system of FIG. 3;

FIG. 6 illustrates an output of a storage device and a flow of a signal for controlling the output in the energy storage system of FIG. 3;

FIG. 7 illustrates an output of a storage device and a flow of a signal for controlling the output in an energy storage system according to another embodiment;

FIG. 8 illustrates a schematic block diagram of an energy storage system according to another embodiment;

FIG. 9 illustrates a flowchart of a method of operating an energy storage system according to another embodiment; and

FIG. 10 illustrates a flowchart of a method of operating an energy storage system according to another embodiment during a discharge mode.

### DETAILED DESCRIPTION

Korean Patent Application No. 10-2010-0129287, filed on Dec. 16, 2010, in the Korean Intellectual Property Office, and entitled: “Energy Storage System and Method of Controlling the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when an element is referred to as being “connected to” another element or “between” two elements, it can be the only element “connected to” another element or “between” two elements, or one or more intervening elements may also be present. Like reference numerals refer to like elements throughout.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated elements, steps, operations, and/or devices, but do not preclude the presence or addition of one or more other elements, steps, operations, and/or devices. It will also be understood that, although the terms first, second, etc. may be used herein to describe various elements, these elements should not be limited by these terms. These terms are only used to distinguish one element from another.

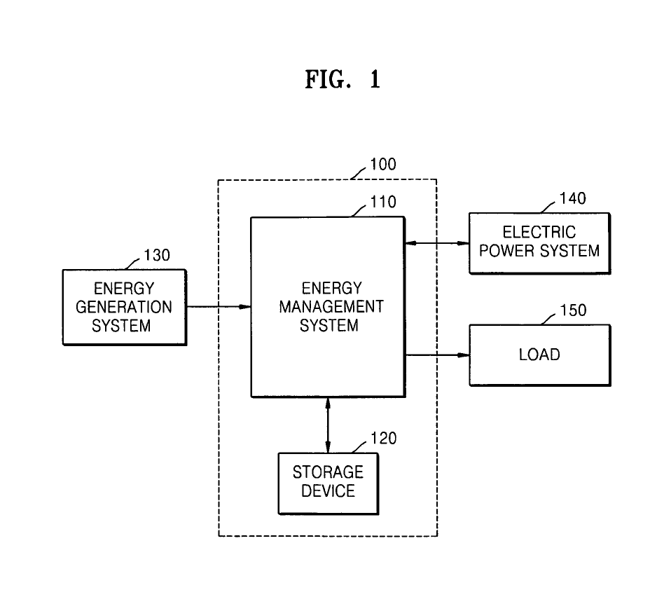

FIG. 1 illustrates a schematic block diagram of an energy storage system 100 according to an embodiment.

Referring to FIG. 1, the energy storage system 100 may include an energy management system 110 and a storage device 120, and may be connected to an energy generation system 130, an electric power system 140, and a load 150.

The energy management system 110 receives energy generated by the energy generation system 130. The energy management system 110 may supply the generated energy to the electric power system 140, store the generated energy in the storage device 120, or supply the generated energy to the load 150. The generated energy from the energy generation system 130 may be direct-current (DC) energy or alternating-current (AC) energy.

Also, the energy management system 110 may supply energy stored in the storage device 120 to the electric power system 140, or may store energy supplied by the electric power system 140 in the storage device 120. Also, the energy management system 110 may perform an uninterruptible power supply (UPS) operation when electric power supplied to the electric power system 110 is interrupted or electric work is carried out, so as to supply energy to the load 150. Furthermore, when the electric power system 140 is in a normal state, the energy management system 110 may supply energy generated by the energy generation system 130 or the energy stored in the storage device 120 to the load 150.

The energy management system 110 may perform energy conversion for storing energy generated by the energy generation system 130 in the storage device 120, energy conversion for supplying the energy generated by the energy generation system 130 to the electric power system 140 or the load 150, and energy conversion for storing energy supplied from the electric power system 140 in the storage device 120. The energy management system 110 may also perform energy conversion for supplying energy stored in the storage device 120 to the electric power system 140 or the load 150. Also, the energy management system 110 may monitor states of the storage device 120, the electric power system 140, and the load 150, and may distribute the energy generated by the energy generation system 130 or the energy supplied by the electric power system 140.

Also, the energy management system 110 may monitor a state of the storage device 120 and may control the storage device 120 when the storage device 120 produces an abnormal output, e.g., when the storage device 120 breaks down within its lifetime, deteriorates, or reaches the end of its lifetime. That is, since application of an abnormal output of the storage device 120 to the electric power system 140 or the load 150 may lead to a significant decrease in stability of the energy storage system 100, the energy management system 110 may monitor and control the abnormal output of the storage device 120. For example, when the energy management system 110 senses an abnormal output of the storage device 120, the energy management system 110 may convert the abnormal output of the storage device 120 into a normal output, e.g., by increasing or decreasing the abnormal output, and may supply the converted output to the electric power system 140 and/or the load 150.

The storage device 120 may be a large-capacity storage device for storing energy supplied from the energy management system 110. In this regard, energy stored in the storage device 120 may be either energy converted from energy generated by the energy generation system 130 or energy converted from commercially available energy supplied by the electric power system 140. The energy stored in the storage device 120 may be supplied to the electric power system 140 or the load 150 under the control of the energy management system 110.

In the present embodiment, the energy storage system 100 includes the energy management system 110 and the storage device 120, e.g., the energy management system 110 and the storage device 120 may be separate elements connected to each other. However, example embodiments are not limited to the components and structure described above, e.g., the energy management system 110 and the storage device 120 may be integrally formed as one body.

The energy generation system 130 may include a system for generating electric energy from new renewable energies, e.g., solar energy, tidal energy, and wind energy. For example, a solar energy generation system may include a solar cell array for converting solar energy into electric energy.

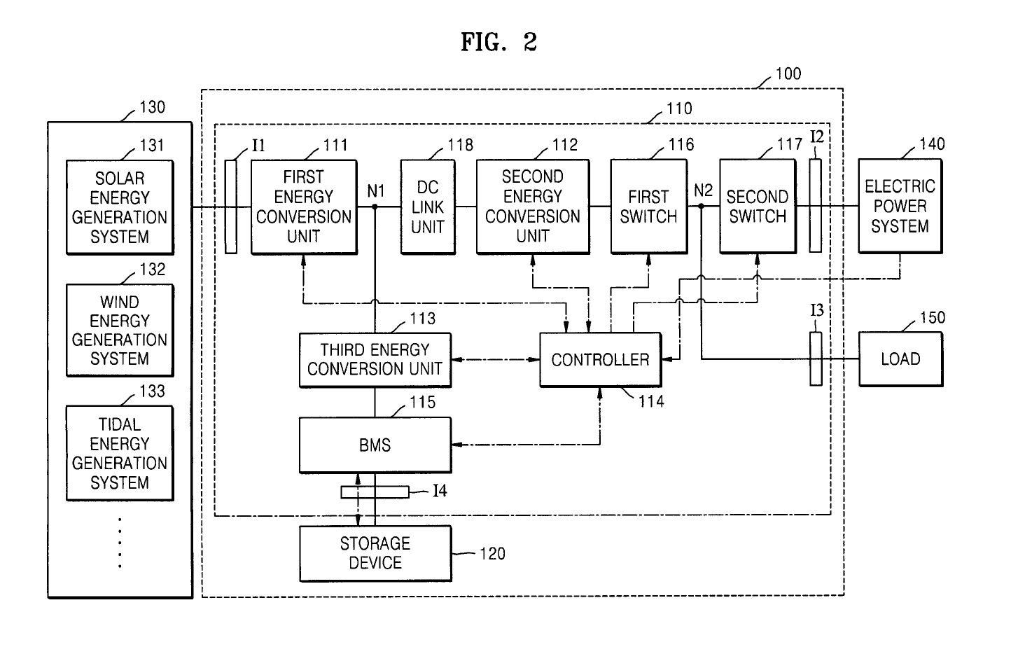

A detailed structure of the energy storage system 100 including the energy management system 110 and the storage device 120 will be described with reference to FIG. 2. FIG. 2 illustrates a detailed block diagram of the energy storage system 100.

Referring to FIG. 2, the energy management system 110 is connected to the energy generation system 130 through a first interface I1, is connected to the electric power system 140 through a second interface I2, is connected to the load 150 through a third interface I3, and is connected to the storage device 120 through a fourth interface I4. The energy management system 110 may include a first energy conversion unit 111, a second energy conversion unit 112, a third energy conversion unit 113, a controller 114, a battery management system (BMS) 115, a first switch 116, a second switch 117, and a direct-current (DC) link unit 118. In FIG. 2, an energy flow among components is indicated by a solid line, and a flow of a control signal among components is indicated by a dashed line.

The first energy conversion unit 111 may be connected to and interposed between the energy generation system 130 and a first node N1. The first energy conversion unit 111 converts energy generated by the energy generation system 130 and supplies the converted energy to the first node N1, e.g., an output of the first energy conversion unit 111 may be DC energy. For example, when the generated energy by the energy generation system 130 is AC energy, the first energy conversion unit 111 converts the AC energy into DC energy. In another example, when the generated energy by the energy generation system 130 is DC energy, the first energy conversion unit 111 converts the DC energy of the energy generation system 130 into DC energy having a different intensity. That is, the first energy conversion unit 111 may perform a rectifying conversion function of converting AC energy into DC energy or DC energy into DC energy having a different intensity therefrom.

The second energy conversion unit 112 may be connected to and interposed between the first node N1 and the electric power system 140. The second energy conversion unit 112 may perform an inverter function of converting DC energy within the energy management system 110 into AC energy of the electric power system 140 in order to supply energy to the electric power system 140. For example, the second energy conversion unit 112 may convert DC energy converted by the first energy conversion unit 111 or DC energy converted by the third energy conversion unit 113 into AC energy of the electric power system 140. Also, the second energy conversion unit 112 may perform a rectifying function of converting commercially available AC energy supplied by the electric power system 140 into DC energy and supplying the converted DC energy to the first node N1. The second energy conversion unit 112 controls conversion efficiency under the control of the controller 114.

The third energy conversion unit 113 may be connected to and interposed between the first node N1 and the storage device 120. The third energy conversion unit 113 may perform a converter function of converting DC energy into DC energy having a different intensity therefrom. For example, the third energy conversion unit 113 may convert DC energy supplied through the first node N1 into DC energy having a different intensity therefrom, and may supply the converted DC energy to the storage device 120. Also, the third energy conversion unit 113 may convert DC energy stored in the storage device 120 into DC energy having a different intensity therefrom, and may supply the converted DC energy to the first node N1. The third energy conversion unit 113 controls conversion efficiency under the control of the controller 114, e.g., the third energy conversion unit 113 controls conversion efficiency according to a control signal transmitted by the controller 114, which senses occurrence of an abnormal output of the storage device 120 so as to increase or reduce the output of the storage device 120.

The first switch 116 and the second switch 117 may be connected to and interposed among the second energy conversion unit 112, the electric power system 140, and the load 150. For example, the first switch 116 and the second switch 117 may block an energy flow among the second energy conversion unit 112, the electric power system 140, and the load 150 under the control of the controller 114. For example, the first switch 116 and the second switch 117 may each be a field effect transistor (FET), a bipolar junction type transistor (BJT), etc., and a switching operation of each of the first switch 116 and the second switch 117 may be controlled by the controller 114.

The DC link unit 118 maintains a DC voltage level of the first node N1 at a constant level, e.g., at a DC link level. Without the DC link unit 118, the first node N1 may have an unstable voltage level, e.g., due to an instantaneous voltage drop of the energy generation system 130 or the electric power system 140 or due to occurrence of a peak load at the load 150. Therefore, the DC link unit 118 according to example embodiments stabilizes the DC voltage level of the first node N1, i.e., maintains the DC voltage level of the first node N1 at a constant DC link voltage, thereby providing stable operation of the second and third energy conversion units 112 and 113 normally.

The BMS 115 may be connected to the storage device 120. The BMS 115 may sense state information, e.g., voltage, current, and temperature, of the storage device 120 to calculate a state of charge (SOC) and a state of health (SOH) of the storage device 120, and may monitor a residual energy and lifetime of the storage device 120 according to the calculation results. The BMS 115 may include a micro computer (not shown) that monitors the state information of the storage device 120 and determines the resultant overcharge, overdischarge, over-current, cell balancing, SOC, or SOH of the storage device 120. The BMS 115 may further include a protection circuit (not shown) for preventing charging, discharging, blowing a fuse, and cooling of the storage device 120 according to a control signal transmitted by the micro computer. The BMS 115 may transmit the monitoring results, i.e., the state information of the storage device 120, to the controller 114.

In the present embodiment, the BMS 115 is included in the energy management system 110 and is separated from the storage device 120. However, according to another embodiment, the BMS 115 and the storage device 120 may be integrally formed as one body.

The controller 114 may control an overall operation of the energy management system 110. The controller 114 may receive sensing signals related to voltage (V), current (I), and temperature (T) transmitted by the first energy conversion unit 111, the second energy conversion unit 112, and the third energy conversion unit 113, and may output a pulse width modulation (PWM) control signal to switching devices of the first through third energy conversion units 111, 112, and 113 so as to control conversion efficiency of the first through third energy conversion units 111, 112, and 113.

The controller 114 may monitor states of the storage device 120, the electric power system 140, and the load 150, and may control a driving mode according to the monitoring results. For example, the driving mode may be a mode in which energy generated by the energy generation system 130 is supplied to the electric power system 140, to the load 150, or to the storage device 120. In another example, the driving mode may be a mode in which energy generated by the energy generation system 130 or commercially available energy supplied by the electric power system 140 is stored in the storage device 120. In yet another example, the driving mode may be a mode in which energy stored in the storage device 120 is supplied to the electric power system 140 or the load 150. According to the driving mode, the controller 140 may control operations and efficiencies of the first energy conversion unit 111, the second energy conversion unit 112, and the third energy conversion unit 113, and on/off operations of the first switch 116 and the second switch 117.

For example, in a mode in which energy stored in the storage device 120 is supplied to the electric power system 140 or the load 150, the controller 114 may monitor a state of the storage device 120 and control an output of the storage device 120 based on state information of the storage device 120 transmitted by the BMS 115. In detail, DC energy stored in the storage device 120 may be converted into DC energy having a different intensity therefrom by the third energy conversion unit 113, so the converted DC energy with the different intensity may be supplied to the first node N1. In this case, if the storage device 120 produces an abnormal output, e.g., an output that is lower or higher than a predetermined value, the controller 114 may generate a control signal for increasing or decreasing the abnormal output of the storage device 120 and may transmit the generated control signal to the third energy conversion unit 113.

The energy generation system 130 may generate electric energy and may output the electric energy to the energy management system 110. For example, the energy generation system 130 may be a solar energy generation system 131, a wind energy generation system 132, and/or a tidal energy generation system 133. Also, the energy generation system 130 may be an energy generation system that generates electric energy from renewable energy, e.g., from solar heat or ground heat.

The electric power system 140 may include, e.g., a power plant, a substation, a power transmission line, etc. The electric power system 140 may supply energy to the storage device 120 or the load 150 according to on/off operations of the first switch 116 and the second switch 117, and may receive energy from the storage device 120.

The load 150 may consume energy generated by the energy generation system 130, energy stored in the storage device 120, or energy supplied by the electric power system 140. For example, the load 150 may be consumer homes or factories.

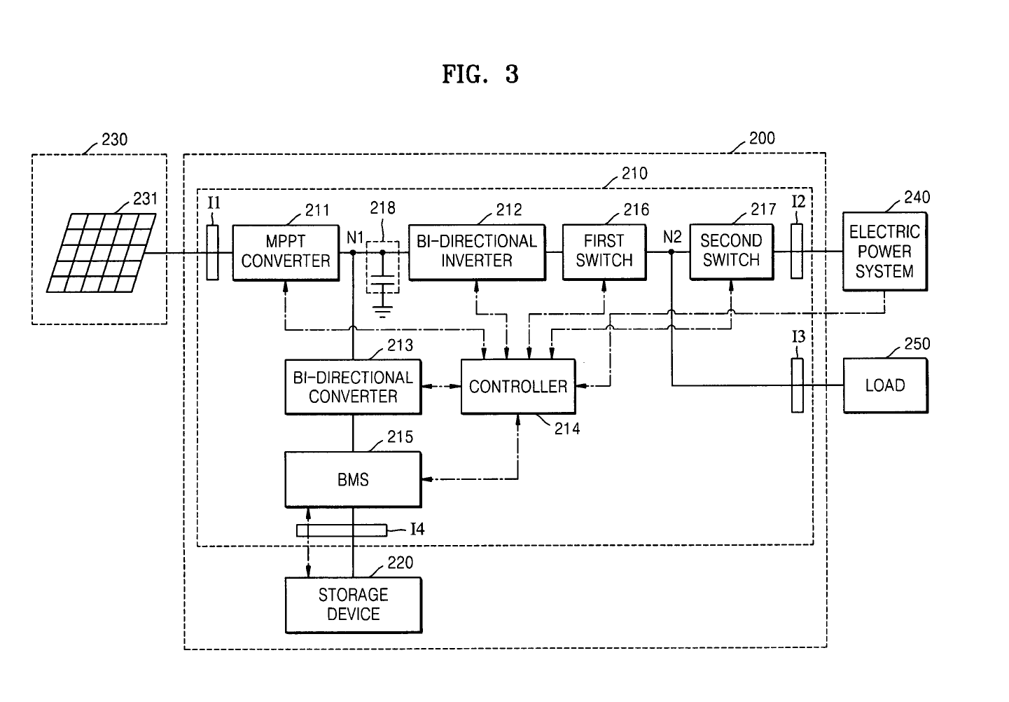

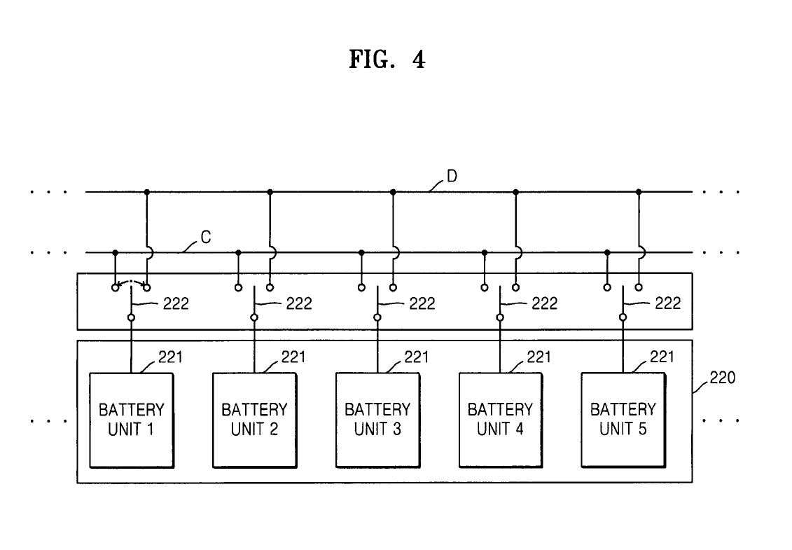

FIG. 3 illustrates a schematic block diagram of an energy storage system 200 according to another embodiment. FIG. 4 illustrates a schematic conceptual diagram of a storage device 220 of the energy storage system 200.

Referring to FIG. 3, an energy management system 210 may include a maximum power point tracking (MPPT) converter 211, a bi-directional inverter 212, a bi-directional converter 213, a controller 214, a BMS 215, a first switch 216, a second switch 217, and a DC linking capacitor 218. The energy management system 210 may be connected to a solar energy generation system 230 including a solar cell 231, to an electric power system 240, to a load 250, and to the storage device 220 through first through fourth interfaces I1, I2, I3, and I4, respectively.

The MPPT converter 211 converts a DC voltage output by the solar cell 231 into a DC voltage of the first node N1. Since the output of the solar cell 231 may change according to weather and load conditions, the MPPT converter 211 may control the solar cell 231 to produce a maximum amount of energy. For example, the MPPT converter 211 may perform MPPT under the control of the controller 214 so as to allow the solar energy generation system 230 to generate the maximum amount of energy.

The DC linking capacitor 218 may be interposed between and connected in parallel to the first node N1 and the bi-directional inverter 212. The DC linking capacitor 218 maintains a DC voltage output by the MPPT converter 211 at a DC link voltage, e.g., a DC 380V voltage, and supplies the DC voltage to the bi-directional converter 213. The DC linking capacitor 218 supplies a stabilized DC link voltage to allow the bi-directional inverter 212 and the bi-directional converter 213 to operate normally. In the present embodiment, the DC linking capacitor 218 may be formed separately with respect to other elements of the energy storage system 200. However, in another embodiment, the DC linking capacitor 218 may be included in the MPPT converter 211, the bi-directional inverter 212, or the bi-directional converter 213.

The bi-directional inverter 212 may be interposed between and connected to the first node N1 and the electric power system 240. The bi-directional inverter 212 may convert an AC voltage into a DC voltage or convert a DC voltage into an AC voltage. That is, the bi-directional inverter 212 may convert a DC voltage of the MPPT converter 211 or the bi-directional converter 213 into an AC voltage of the electric power system 240 or the load 250, or convert an AC voltage of the electric power system 240 into a DC voltage to be supplied to the first node N1.

The bi-directional inverter 212 may rectify an AC voltage input by the electric power system 240 through the first switch 216 and the second switch 217 into a DC voltage for storage in the storage device 220, and may rectify a DC voltage output by the solar energy generation system 230 or the storage device 220 into an AC voltage of the electric power system 240 or the load 250 to be output to the electric power system 240 or the load 250. In this regard, an AC voltage output to the electric power system 240 needs to satisfy an energy quality condition of the electric power system 240. To do this, the bi-directional inverter 212 may synchronize a phase of an output AC voltage with a phase of the electric power system 240 to suppress invalid energy generation and to control an AC voltage level.

The bi-directional converter 213 may be interposed between and connected to the first node N1 and the storage device 220, and may convert a DC voltage of the first node N1 into a DC voltage for storage in the storage device 220, i.e., convert the DC voltage to voltage of different intensity. Also, the bi-directional converter 213 may convert a DC voltage stored in the storage device 220 into a DC voltage for supply to the first node N1. For example, when DC energy generated by the solar energy generation system 230 is to be charged in the storage device 220 or when AC energy supplied by the electric power system 240 is to be charged in the storage device 220, i.e., when the storage device 220 is in a charging mode, the bi-directional converter 213 may reduce a DC voltage level of the first node N1 or a DC link voltage level maintained by the DC linking capacitor 218, e.g., DC 380 V, to a storage voltage of the storage device 220, e.g., DC 100 V. In another example, when energy stored in the storage device 220 is supplied to the electric power system 240 or the load 250, i.e., when the storage device 220 is in a discharging mode, the bi-directional converter 213 may increase a storage voltage of the storage device 220, e.g., DC 100V, to a DC voltage level of the first node N1 or to a DC link voltage level maintained by the DC linking capacitor 218, e.g., DC 380 V. IN yet another example, when the storage device 220 is in a discharging mode and produces an abnormal output, e.g., an output voltage of about DC 400 V or about DC 50 V, the bi-directional converter 213 may decrease or increase the voltage to the DC voltage level of the first node N1 or the DC link voltage level maintained by the DC linking capacitor 218, i.e., DC 380 V.

Operations of the BMS 115, the first switch 116, and the second switch 117 have already been described above with reference to FIG. 2. The BMS 215, the first switch 216, and the second switch 217 are equivalent to the BMS 115, the first switch 116, and the second switch 117, and therefore, operations thereof will not be described herein.

The storage device 220 may store energy supplied by the energy management system 210, and may includes a plurality of rechargeable battery units 221 (FIG. 4). The storage device 220 may store energy that is converted from energy generated by the energy generation system 230 or energy that is converted from energy supplied by the electric power system 240. For example, the battery units 221 may include a nickel-cadmium battery, a lead storage battery, a nickel-hydrogen battery, a lithium ion battery, a lithium polymer battery, etc.

Referring to FIG. 4, the storage device 220 may include the battery units 221 electrically connected to each other, and switches 222 respectively connected to the battery units 221. Each of the battery units 221 may includes a plurality of cells connected in series. The battery units 221 may be connected in parallel to each other, and each of the battery units 221 may be charged and discharged independently. In the present embodiment, the number of battery units 221 illustrated is five (5). However, the number of battery units may differ according to energy capacity or manufacturing conditions required for a storage device.

The switches 222 control charging and discharging of the battery units 221. For example, the switches 222 may be controlled to connect the battery units 221 to a charging pass C to store energy generated by the energy generation system 230 or energy supplied by the electric power system 240. In another example, the switches 222 may be controlled to connect the battery units 221 to a discharging pass D to supply energy to the electric power system 240 or the load 250. Meanwhile, if some of the battery units 221 have defects and are not able to be repaired, the switches 222 may not be connected to any of the charging pass C and the discharging pass D.

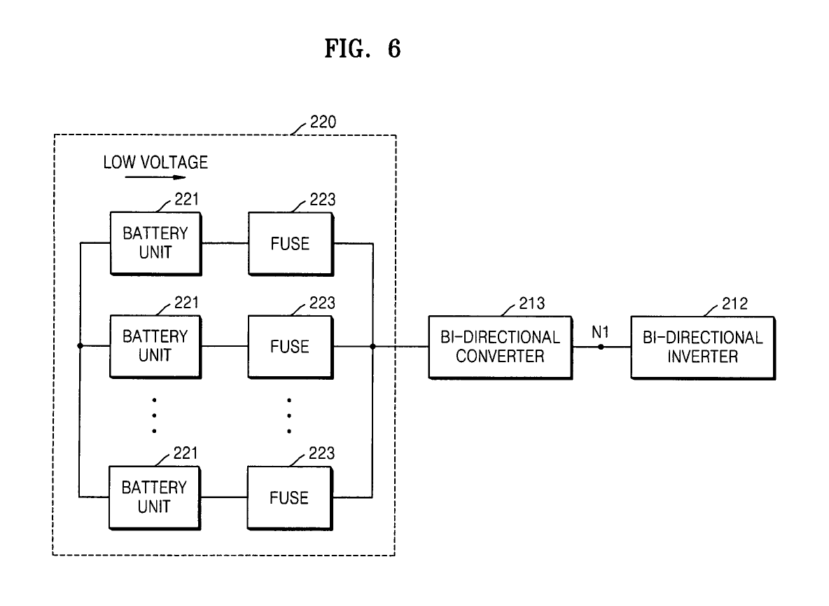

For example, when the switches 222 connect the battery units 221 to the discharging pass D, i.e., in a discharging mode, and some of the battery units 221 are over-discharged, the controller 214 may generate a control signal for decreasing an abnormally high output voltage of the storage device 220, i.e., an abnormally high output voltage of the storage device 220 caused by the over-discharged battery units 221. In another example, if some of the battery units 221 have defects and cause an abnormally low output voltage, the controller 214 may generate a control signal for increasing the voltage output by the storage device 220. The process of controlling the output of the storage device 220 by the controller 214 will be described in detail with reference to FIG. 6 later.

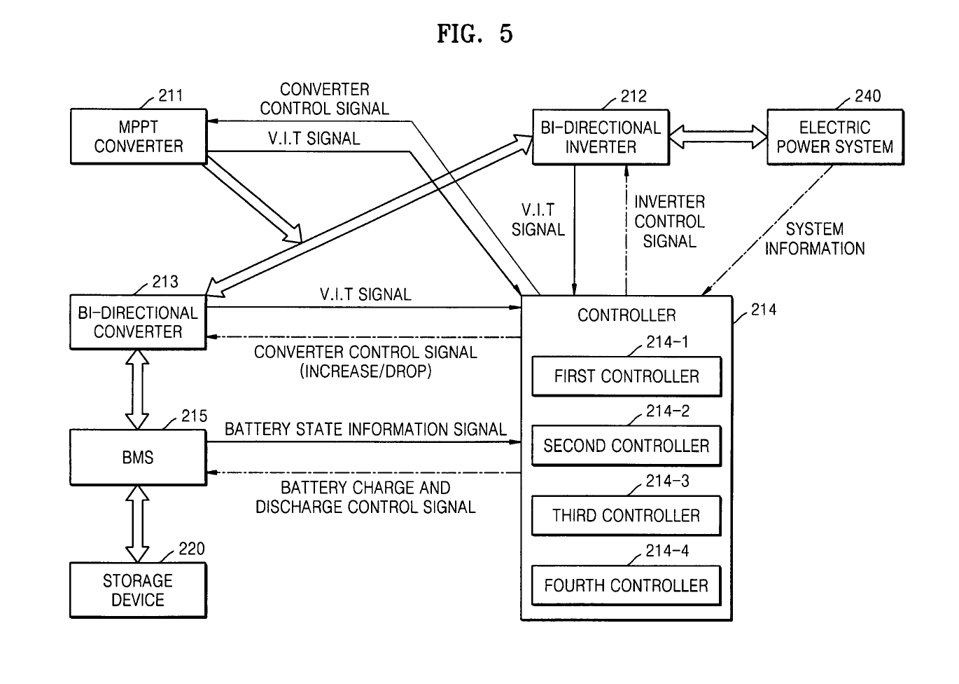

The controller 214 may controls overall operations of the energy management system 210. FIG. 5 illustrates a flowchart of energy and control signals of the energy management system 210 of FIG. 3.

Referring to FIG. 5, the controller 214 controls overall operations of the energy management system 210 and determines a driving mode of the energy management system 210. For example, the controller 214 may determine whether energy generated by the energy generation system 230 is to be supplied to the electric power system 240, to the load 250, or to the storage device 220. In another example, the controller 214 may determine whether energy generated by the energy generation system 230 or commercially available energy supplied by the electric power system 240 is to be stored in the storage device 220. In yet another example, the controller 214 may determine whether energy stored in the storage device 220 is to be supplied to the electric power system 240 or to the load 250. To do this, the controller 214 may include a first control unit 214-1, a second control unit 241-2, a third control unit 214-3, and a fourth control unit 214-4.

The first control unit 214-1 may control supply of energy generated by the energy generation system 230 to at least one of the electric power system 240, the load 250, and the storage device 220. For example, the first control unit 214-1 may receive a signal related to voltage, current, or temperature transmitted by the MPPT converter 221 and may transmit a control signal to the MPPT converter 221 so as to allow a DC level voltage converted by the MPPT converter 221 to be supplied to either the bi-directional inverter 212 or the bi-directional converter 213.

The second control unit 214-2 may control supply of energy supplied by the electric power system 240 to at least one of the storage device 220 and the load 250. For example, the second control unit 214-2 may receive a signal related to voltage, current, or temperature transmitted by the bi-directional inverter 212 and may transmit a control signal to the bi-directional inverter 212 so as to allow the energy supplied by the electric power system 240 to be supplied to the load 250 or the storage device 220.

The second control unit 214-2 may receive system information from the electric power system 240 and may monitor a state of the electric power system 240. For example, if the electric power system 240 undergoes electric power interruption, under the control of the second control unit 214-2, the bi-directional inverter 212 supplies energy generated by the electric power system 240 to the load 250 in connection with the first control unit 214-1, or supplies energy stored in the storage device 220 to the load 250 in connection with the third control unit 214-3, which will be described later.

If the energy stored in the storage device 220 is to be sold, the second control unit 214-2 generates a control signal needed for the selling based on information about the electric power system 240 and transmits the control signal to the bi-directional inverter 212.

The third control unit 214-3 may control supply of energy stored in the storage device 220 to at least one of the electric power system 240 and the load 250. For example, the third control unit 214-3 may receive a signal related to voltage, current, or temperature transmitted by the bi-directional inverter 213 and may transmit a control signal to the bi-directional inverter 213 so as to allow the stored energy to be supplied to the electric power system 240 or the load 250.

Also, the third control unit 214-3 may transmit to the bi-directional converter 213 a control signal that allows energy generated by the energy generation system 230 or commercially available energy supplied by the electric power system 240 to be stored in the storage device 220, thereby allowing the BMS 215 to control charging and discharging of the storage device 220.

The fourth control unit 214-4 may monitor whether the storage device 220 produces an abnormal output based on state information about the storage device 220. To do this, the fourth control unit 214-4 may receive the state information about the storage device 220 from the BMS 215. In this regard, the state information about the storage device 220 may include information about voltage, current, or temperature of each of the battery units 221.

Also, the fourth control unit 214-4 may determine an output increase or an output drop, i.e., output decrease, ratio with respect to an abnormal output and may transmit information about the output increase or drop ratio to the bi-directional converter 213. The output increase or drop ratio may be determined by comparing an abnormal output value of the storage device 220 and a normal output value of the storage device 220. The normal output value of the storage device 220 may be within a predetermined range and may be set in the fourth control unit 214-4 in advance. The fourth control unit 214-4 may generate a control signal corresponding to the output increase or drop ratio, and may transmit the control signal to the bi-directional converter 213, and the bi-directional converter 213 may increase or drop the abnormal output voltage of the storage device 220 according to the control signal.

In the present embodiment, the fourth control unit 214-4 and the third control unit 214-3 are separate components. However, the function of the fourth control unit 214-4 may be incorporated into the third control unit 214-3.

Also, in the present embodiment, the controller 214 includes the first through fourth control units 214-1 through 214-4 in corresponding first through fourth controllers 214-1 through 214-4, respectively. As such, the first through fourth control units 214-1 through 214-4 may be used interchangeably with respective first through fourth controllers 214-1 through 214-4. However, in another embodiment, one controller may perform operations of the first through fourth control units 214-1, 214-2, 214-3, and 214-4, or each of the first through fourth control units 214-1, 214-2, 214-3, and 214-4 may operate as an independent device.

FIG. 6 illustrates an output of the storage device 220 and a flow of a signal for controlling the output in the energy storage system 200 of FIG. 3.

Referring to FIG. 6, the storage device 220 may include the battery units 221 connected in parallel, and each of the battery units 221 may include a plurality of cells connected in series. Each of the battery units 221 may be connected to a fuse, and although not illustrated in FIG. 6, a BMS for transmitting a state of a corresponding battery unit to the controller 214 may be installed on each of the battery units 221. If some of the battery units 221 break down, and thus the battery units 221 outputs a low voltage, a total voltage of the storage device 220 applied to the bi-directional converter 213 may drop.

In this case, the controller 214 monitors a state of each of the battery units 221 through the corresponding BMS and transmits a control signal for increasing the drop voltage to the bi-directional converter 213. The bi-directional converter 213 increases the output voltage of the storage device 220 according to the control signal and then supplies the output voltage to the first node N1.

In the present embodiment, a case in which some of the battery units 221 break down and cause a low voltage output has been described. However, when the battery units 221 output a high voltage, the bi-directional converter 213 operates in the same manner as described above, except that a total voltage of the storage device 220 is dropped.

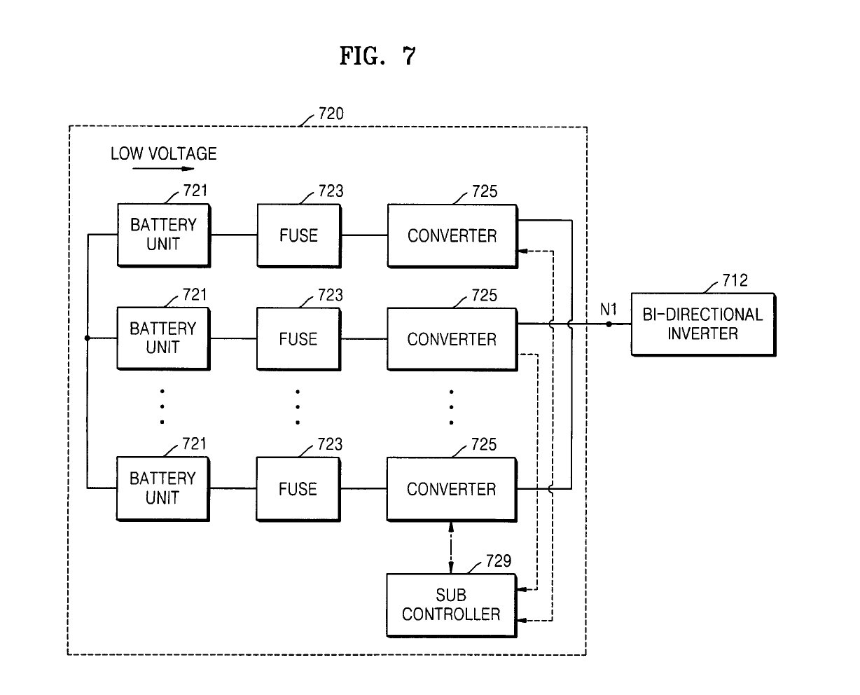

FIG. 7 illustrates an output of a storage device 720 and a flow of a signal for controlling the output in an energy storage system according to another embodiment.

Referring to FIG. 7, like the storage device 220 of FIG. 6, the storage device 720 may include battery units 721 connected in parallel, and each of the battery units 721 may include a plurality of cells connected in series. Each of the battery units 721 may be connected to a fuse.

However, in the present embodiment, the storage device 720 may include a plurality of converters 725 connected in series to respective battery units 721, and a sub controller 729 for controlling each of the converters 725. The converters 725 correspond to a bi-directional converter and may participate in charging or discharging of the battery units 721. Hereinafter, the difference between the storage device 220 of FIG. 6 and the storage device 720 of FIG. 7 will be described in detail.

In the present embodiment, the sub controller 729 corresponds to the fourth control unit 214-4 of the controller 214 described with reference to FIG. 5. When any one of the battery units 721 breaks down, a BMS (not shown) transmits state information about the battery units 721 to the sub controller 729, and the sub controller 729 determines whether the battery units 721 produce an abnormal output and increases or drops the output of the battery units 721. In this case, whether the battery units 721 are at a normal state or an abnormal state is determined by comparing the output of the battery units 721 with a normal output value (or a normal output voltage range) of the battery units 721 to obtain an output increase or drop ratio. Meanwhile, the output increase or drop ratio may correspond to a difference between an abnormal output value of battery units and a normal output value (or an average value of a normal output voltage range).

Under the control of the sub controller 729, an output of the storage device 220 is maintained to be a normal output. The normal output is transmitted to the bi-directional inverter 712, thereby allowing energy to be supplied to an electric power system or a load.

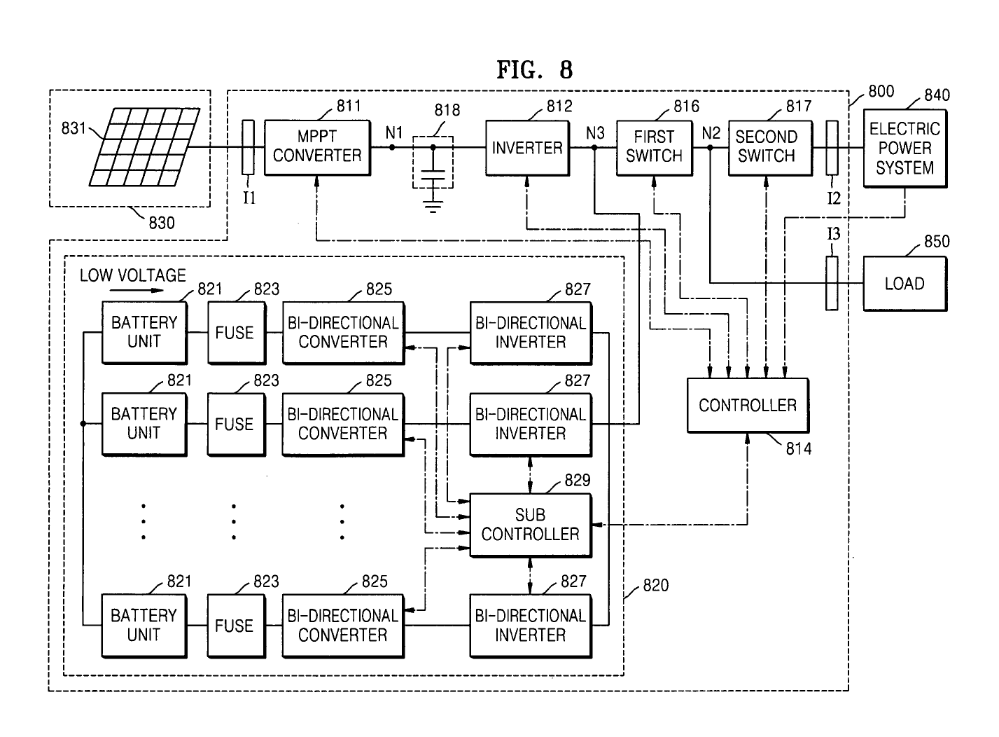

FIG. 8 illustrates a schematic block diagram of an energy storage system 800 according to another embodiment.

The energy storage system 800 may include an MPPT converter 811, an inverter 812, a controller 814, a BMS 815, a first switch 816, a second switch 817, and a DC linking capacitor 818. Also, the energy storage system 800 is the same as the energy storage system 200 described with reference to FIGS. 2 through 7 in that the energy storage system 800 is connected to a solar energy generation system 830 including a solar cell 831, an electric power system 840, and a load 850 through first through third interfaces I1, I2, and I3, respectively.

However, in the energy storage system 800 according to the present embodiment, an energy management system and a storage device are integrally formed as one body. For example, the energy storage system 800 is different from the energy storage systems 100 and 200 in that the storage device 820 includes battery units 821, bi-directional converters 825, and bi-directional inverters 827. Hereinafter, the difference will be described in detail.

The MPPT converter 811 converts a DC voltage output by the solar cell 831 into a DC voltage of the first node N1, and the DC linking capacitor 818 maintains the DC voltage output by the MPPT converter 811 at a DC link voltage and transmits the DC link voltage to the inverter 812.

The inverter 812 converts the DC voltage of the MPPT converter 811 into an AC voltage of the load 850 or the electric power system 840.

The first switch 816 and the second switch 817 block an energy flow among the inverter 812, the electric power system 840, and the load 850. According to a switching operation of the first switch 816, an AC voltage converted by the inverter 812 is supplied to and stored in the storage device 820, or supplied to the electric power system 840 or the load 850. According to a switching operation of the second switch 817, an energy flow between the electric power system 840 and the load 850 is controlled.

The controller 814 controls an overall operation of the energy storage system 800. The controller 814 controls energy conversion efficiency of the MPPT converter 811, the inverter 812, and the storage device 820, and monitors states of the electric power system 840 and the load 850 and controls a driving mode according to monitoring results as described above.

In a mode in which energy generated by the solar energy generation system 830 or energy supplied by the electric power system 840 is stored, the bi-directional inverters 827 included in the storage device 820 convert an AC voltage converted by the inverter 812 or an AC voltage supplied by the electric power system 840 into a DC voltage and supply the DC voltage to the bi-directional converters 825. The bi-directional converters 825 convert the DC voltage into a DC voltage for storage in the battery units 821.

In a mode in which energy stored in the battery units 821 is supplied to the electric power system 840 or the load 850, if some of the battery units 821 output a low voltage, the bi-directional converters 825 connected in series to the battery units 821 outputting a low voltage increase the output to convert the abnormal output into a normal output. Then, the normal output is converted into an AC voltage by the bi-directional inverters 827.

A case in which the battery units 821 break down and output a low voltage has been described above. However, when the battery units 821 output a high voltage, the bi-directional converters 825 operate in the same manner as described above, except that the output voltage is dropped.

The sub controller 829 monitors a state of the battery units 821, senses whether an output of the battery units 821 is an abnormal output, and determines an output increase or drop ratio for the bi-directional converters 825. To do this, the sub controller 829 receives information about voltage, energy, and temperature of the battery units 821 from a BMS (not shown) connected to each of the battery units 821. For example, whether the battery units 821 are at a normal state or an abnormal state is determined by comparing a normal output value (or a normal output voltage range) of the battery units 821 that has been set in advance and an abnormal output of the battery units 821. Meanwhile, the output increase or drop ratio may correspond to a difference between the abnormal output of battery units and the normal output (or an average value of the normal output range).

Also, the sub controller 829 controls, besides an operation of the bi-directional converters 825, an operation of the bi-directional inverters 827. In this case, the sub controller 829 performs its operation according to a control signal, for storing energy in storage or for supplying stored energy, transmitted by the controller 814.

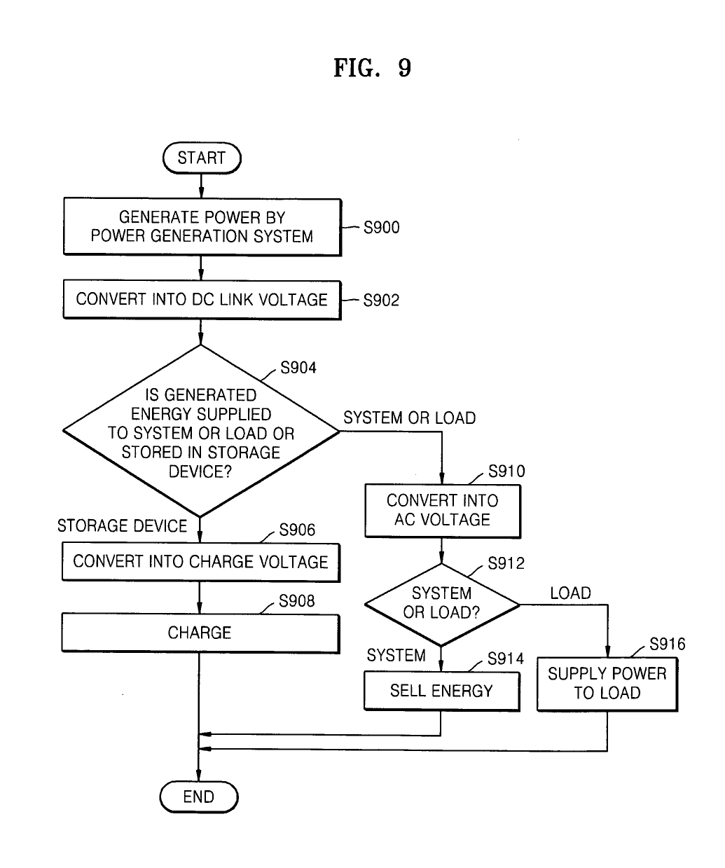

FIG. 9 is a flowchart illustrating a method of operating an energy storage system according to an embodiment.

In operation S900, a renewable energy generation system generates energy. In this regard, the renewable energy generation system may include a solar energy generation system, a wind energy generation system, a tidal energy generation system, etc., and the generated energy may be DC energy or AC energy.

In operation S902, a voltage of the generated energy is converted into a DC link voltage. In this regard, since a voltage level of the energy generated in operation S900 is unstable, there is a need to stabilize the unstable voltage level to a constant DC voltage level to apply the voltage to an inverter or a converter. The DC link voltage refers to the stabilized DC voltage.

In operation S904, it is determined whether the energy generated in operation S900 is supplied to a system or a load or stored in a storage device. In this regard, determination elements taken into consideration include an energy sales price that is currently applied to the system, an amount of generated energy, an amount of energy supplied to the load, and an amount of energy with which the storage device is charged.

If the generated energy is stored in the storage device in operation S904, the DC link voltage converted in operation S902 is converted into a storage device charge voltage in operation S906. Next, the storage device is charged with the generated energy in operation 5908.

In operation S910, if the generated energy is supplied to the system or the load in operation S904, the DC link voltage converted in operation S902 is converted into an AC voltage that satisfies an AC voltage condition of the system or the load. In operation S912, it is determined whether the converted AC voltage is supplied to the system or the load. In operation S914, the AC voltage is supplied to the system, i.e., an electricity sale is performed, and in operation S916, the converted AC voltage is supplied to the load.

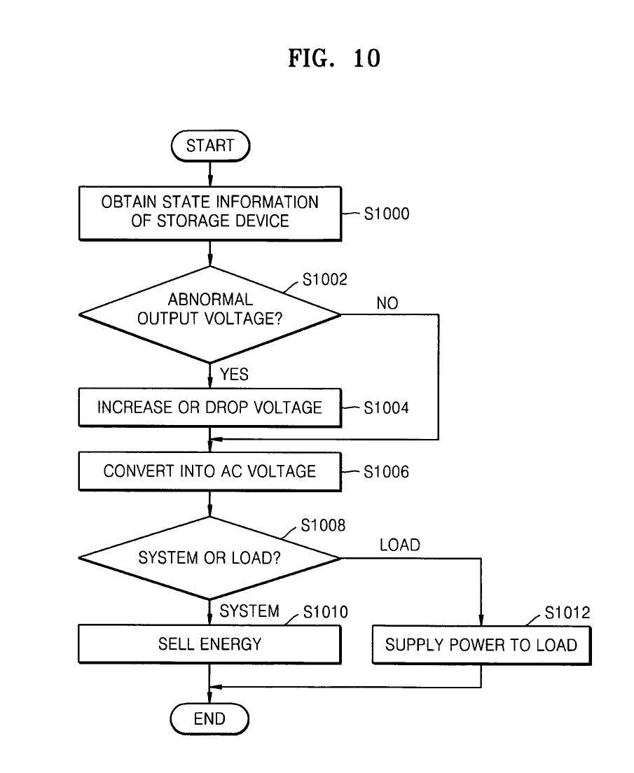

FIG. 10 is a flowchart illustrating a method of operating an energy storage system according to another embodiment, when a storage device is in a discharge mode.

In operation S1000, a state of the storage device is monitored. In this regard, the state of the storage device includes energy state, such as voltage, current, and temperature of each battery unit.

In operation S1002, it is determined whether the storage device produces an abnormal output based on the state information. The abnormal output refers to an abnormally high or low voltage in view of the state information of each battery unit of the storage device.

If the output voltage is determined as abnormal in operation S1002, in operation S1004, the output voltage of the storage device is increased or decreased so as to control the abnormal output voltage. In this regard, an output increase or drop ratio is determined by comparing the abnormal output voltage to a predetermined voltage reference value, e.g., a normal output voltage range that has been set in advance. By increasing or dropping, i.e., decreasing, the output voltage of the storage device, a normal voltage value may be output to a first node.

If the output voltage is determined as normal in operation S1002, in operation S1006, a DC voltage is converted into an AC voltage. Next, in operation S1008, it is determined whether the converted AC voltage is supplied to an electric power system or a load.

In operation S1010, the converted energy is supplied to an electric power system to be sold. In operation S1012, energy stored in the storage device is supplied to the load. Supply of energy stored in the storage device to the load may be performed when the electric power system operates abnormally, e.g., when electricity interruption occurs or electric work is performed.

As described above, according to the one or more of the above embodiments, supply of energy is controllable in connection with an energy generation system and an electric power system, and when stored energy is supplied, even when a storage device produces an abnormal output, energy is supplied stably and efficiently. Such an energy storage system may be used for storing energy during the nighttime or for storing various new renewable energies, e.g., solar energy, tidal energy, and wind energy, for use during the daytime.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. An energy storage system, comprising:
a storage device configured to store energy generated by an energy generation system and to supply the stored energy to an electric power system; and
a controller configured to monitor an output of the storage device and, when the output is within an abnormal output range, to control the output to be in a normal output range.

2. The energy storage system as claimed in claim 1, wherein:
the controller is configured to compare the output of the storage device with a predetermined reference range to determine whether the output is in the abnormal output range, the controller being configured to generate a control signal for increasing or decreasing the abnormal output of the storage device to be within the predetermined reference range if the output is determined to be within the abnormal output range, and
the energy storage system includes an energy converter for increasing or decreasing the output according to a control signal transmitted by the controller.

3. The energy storage system as claimed in claim 1, further comprising a storage device management module for obtaining state information of the storage device and transmitting the state information to the controller.

4. The energy storage system as claimed in claim 1, wherein the storage device includes a plurality of battery units electrically connected to each other.

5. The energy storage system as claimed in claim 4, wherein the controller is configured to obtain state information of each of the battery units, and is configured to determine whether the output of the storage device is in the abnormal output range based on the state information.

6. The energy storage system as claimed in claim 1, wherein the storage device includes:
a plurality of battery units; and
a plurality of energy converters electrically connected to respective battery units.

7. The energy storage system as claimed in claim 6, wherein the controller is configured to compare a predetermined reference range with output voltages of the battery units and to determine whether the output voltages are within the abnormal output range, and if the output voltages are within the abnormal output range, the controller is configured to transmit a control signal for increasing or decreasing the output voltages to be within the predetermined reference range to energy converters that are electrically connected to the battery units.

8. An energy storage system, comprising:
a first interface connected to an energy generation system;
a second interface connected to an electric power system;
a third interface connected to a load;
a storage device configured to store energy generated by the energy generation system and/or energy supplied by the electric power system, and to supply the stored energy to at least one of the electric power system and the load; and
a controller configured to monitor an output of the storage device and, when the output is determined to be within an abnormal output range, to control the output to be a normal output range.

9. The energy storage system as claimed in claim 8, wherein:
the controller is configured to compare the normal output voltage, which has been set in advance, with the output of the storage device and to determine whether the output is in the abnormal output range, and if the output is determined to be within the abnormal output range, the controller is configured to generate a control signal for increasing or decreasing the abnormal output of the storage device to be within the normal output range, and
the energy storage system includes an energy converter for increasing or decreasing the output according to a control signal transmitted by the controller.

10. The energy storage system as claimed in claim 8, further comprising a storage device management module for obtaining state information of the storage device and transmitting the state information to the controller.

11. The energy storage system as claimed in claim 8, wherein the storage device includes a plurality of battery units electrically connected to each other.

12. The energy storage system as claimed in claim 11, wherein the controller is configured to obtain state information of each of the battery units, and to determine whether the output of the storage device is in the abnormal output range based on the state information.

13. The energy storage system as claimed in claim 8, wherein the storage device includes:
a plurality of battery units; and
a plurality of energy converters electrically connected to respective battery units.

14. The energy storage system as claimed in claim 13, wherein the controller is configured to compare the normal output range, which has been set in advance, of the battery units with output voltages of the battery units and to determine whether the output voltages are within the abnormal output range, and if the output voltages are within the abnormal output range, the controller is configured to transmit a control signal for increasing or decreasing the output voltages so that the output of each of the battery units is within the normal output range to energy converters that are electrically connected to battery units that are determined to be in the abnormal output range.

15. The energy storage system as claimed in claim 8, wherein the controller includes:
a first control unit configured to control supply of the energy generated by the energy generation system to at least one of the load, the storage device, and the electric power system;
a second control unit configured to control supply of commercially available energy supplied by the electric power system to at least one of the load and the storage device;
a third control unit configured to control supply of the energy stored in the storage device to at least one of the load and the electric power system; and
a fourth control unit configured to sense whether the output of the storage device is within the abnormal output range and to determine an output increase or decrease ratio of the abnormal output voltage.

16. The energy storage system as claimed in claim 8, further comprising:
a first energy conversion unit that is connected to the first interface and converts the energy generated by the energy generation system;
a second energy conversion unit that is connected to the second interface and the third interface and converts energy supplied to the electric power system and the load; and
a third energy conversion unit that is interposed between and connected to the storage device and a node between the first energy conversion unit and the second energy conversion unit and converts the energy stored in the storage device and outputs the energy to the node.
